(19) United States
(12) Patent Application Publication
(10) Pub. No.: US 2026/0004114 A1
(43) Pub. Date: Jan. 1, 2026

(54) METHOD AND SYSTEM FOR GENERATING BROADCAST CUE SHEET BASED ON REVIEW DATA

(71) Applicant: NAVER CORPORATION, Seongnam-si (KR)

(72) Inventors: Isaac KIM, Seongnam-si (KR); Soonwon KA, Seongnam-si (KR); Jaewook KANG, Seongnam-si (KR); Dong Wook PARK, Seongnam-si (KR); Boram BYUN, Seongnam-si (KR)

(21) Appl. No.: 19/319,821

(22) Filed: Sep. 5, 2025

Related U.S. Application Data
(63) Continuation of application No. PCT/KR2024/002605, filed on Feb. 28, 2024.

(30) Foreign Application Priority Data
Mar. 8, 2023 (KR) 10-2023-0030562

(51) Int. Cl. G06N 3/0475; G06F 16/3329; G06F 40/253; G06F 40/284; G06F 40/30; G06Q 30/0282; G10L 13/02; G10L 13/08

(52) U.S. Cl. CPC G06N 3/0475; G06F 16/3329; G06F 40/253; G06F 40/284; G06F 40/30; G06Q 30/0282; G10L 13/02; G10L 13/08

(57) ABSTRACT

A method for generating a broadcast cue sheet includes receiving a user input including information for specifying a product; extracting one or more keywords from review data associated with the product; and generating a broadcast cue sheet on the basis of the one or more keywords by using a language generation model.

### CROSS-REFERENCE TO RELATED APPLICATIONS

This is a continuation application of International Application No. PCT/KR2024/002605, filed Feb. 28, 2024, which claims the benefit of Korean Patent Application No. 10-2023-0030562, filed Mar. 8, 2023.

### BACKGROUND OF THE INVENTION

### Field of the Invention

The present disclosure relates to a method and a system for generating a broadcast cue sheet and, more specifically, to a method and a system for extracting keywords from review data associated with a product selected by a user and generating a broadcast cue sheet on the basis of the extracted keywords using a language generation model.

### Description of Related Art

Recently, as online commerce has grown rapidly along with the development of the Internet, the online commerce market, such as TV home shopping and live commerce, has also grown rapidly in size. Here, live commerce may refer to an e-commerce form for introducing and selling products to viewers through real-time video streaming. That is, online commerce may refer to a combination of online shopping and broadcasting that are conducted in real time.

A broadcast script (or cue sheet) is typically created in order to conduct a broadcast in the live commerce market. In the past, the task of writing the broadcast script was entrusted to a professional broadcast script writer, or a broadcast production company researched associated materials and created a broadcast script, or often reused an existing broadcast script. However, this method may consume a lot of time and money in writing the broadcast script. In addition, there is a problem that the quality of the broadcast deteriorates when an existing broadcast script, written for a product different from a new product, is reused.

### BRIEF SUMMARY OF THE INVENTION

The present disclosure describes a method and a system (device) for generating a broadcast cue sheet on the basis of review data to solve the above problems.

The present invention may be implemented in various ways, including as a method, a device (system), or a computer program stored on a computer-readable storage medium.

According to an embodiment of the present invention, a method for generating a broadcast cue sheet based on review data may include: receiving a user input including information for specifying a product; extracting one or more keywords from review data associated with the product; and generating a broadcast cue sheet on the basis of the one or more keywords using a language generation model.

An embodiment of the present invention also includes a non-transitory computer-readable recording medium recording instructions for executing the broadcast cue sheet generation method on a computer.

A system for generating a broadcast cue sheet according to an embodiment of the present invention may include a communication module, a memory, and at least one processor connected to the memory and configured to execute at least one computer-readable program included in the memory, wherein the at least one program may include instructions for receiving a user input including information for specifying a product, extracting one or more keywords from review data associated with the product, and generating a broadcast cue sheet on the basis of the one or more keywords using a language generation model.

According to various embodiments of the present invention, a user can conveniently receive a broadcast cue sheet simply by entering information for specifying a product. In addition, users can easily reflect their intentions in the broadcast cue sheet by modifying automatically generated keywords or cue sheets. Accordingly, the time and cost required for creating a broadcast cue sheet can be significantly reduced.

According to various embodiments of the present disclosure, a user can easily identify the review keywords of a relevant product simply by entering information for specifying a product. In addition, through preprocessing and postprocessing of answer data generated for questions related to the product, uncertainty in the subsequent keyword extraction step can be reduced, thereby improving the reliability of the review keywords.

According to various embodiments of the present invention, a sentence for a broadcast cue sheet can be processed more appropriately by first generating short sentences, instead of directly generating a long sentence from keywords. In addition, it is possible to prevent the generation of long sentences that are unsuitable for broadcasting by filtering out prohibited words or the like from short sentences before generating a long sentence.

According to various embodiments of the present invention, a long sentence capable of conveying meaning may be generated from bullet-point short sentences generated from keywords related to a product. In addition, it is possible to generate a broadcast cue sheet with a natural context and composition by segmenting and modularizing the cue sheet into blocks using prompts. In addition, by generating a cue sheet using keywords labeled based on predetermined questions, the composition of the cue sheet may be structured and the content of the cue sheet can be effectively conveyed.

According to various embodiments of the present invention, a user can easily understand the content of the broadcast cue sheet by identifying the overall composition of the broadcast cue sheet. In addition, a user can use a more complete cue sheet by modifying the content of the broadcast cue sheet generated by a language generation model. Furthermore, a user can effectively rehearse a live commerce broadcast by playing back a voice synthesis result of the cue sheet reflecting the speech style of a show host.

According to various embodiments of the present invention, the composition of the broadcast cue sheet may be segmented/modularized into blocks. Accordingly, the content of each block constituting the cue sheet can be created more smoothly, and the overall composition of the cue sheet can be naturally connected. In addition, the composition of the cue sheet can be flexibly adjusted according to the prompt input by the user.

The effects of the present invention are not limited to the effects mentioned above, and other effects not mentioned will be clearly understood by those skilled in the art to which the present disclosure pertains from the description of the claims.

### BRIEF DESCRIPTION OF THE DRAWINGS

The embodiments of the present invention will be described with reference to the accompanying drawings, wherein like reference numerals represent like elements, but are not limited thereto.

FIGS. 1A and 1B are diagrams illustrating an example of a method for generating a broadcast cue sheet according to an embodiment of the present invention.

FIG. 2 is a schematic diagram illustrating a configuration in which an information processing system is connected to a plurality of user terminals to be able to communicate with each other in order to generate a broadcast cue sheet according to an embodiment of the present invention.

FIG. 3 is a block diagram illustrating the internal configuration of a user terminal and an information processing system according to an embodiment of the present invention.

FIG. 4 is a flowchart illustrating a method for generating a cue sheet according to an embodiment of the present invention.

FIG. 5 is a diagram illustrating an example of extracting keywords from review data according to an embodiment of the present invention.

FIG. 6 is a diagram illustrating an example of generating bullet-point short sentences from keywords according to an embodiment of the present invention.

FIG. 7 is a diagram illustrating an example of generating a broadcast cue sheet according to an embodiment of the present invention.

FIGS. 8A and 8B are diagrams illustrating an example of a broadcast cue sheet according to an embodiment of the present invention.

FIG. 9 is a diagram illustrating an example of a broadcast cue sheet composition according to an embodiment of the present invention.

FIG. 10 is a diagram illustrating an example of an opening block of a broadcast cue sheet according to an embodiment of the present invention.

FIG. 11 is a diagram illustrating an example of a body block of a broadcast cue sheet according to an embodiment of the present invention.

FIG. 12 is a diagram illustrating an example of a closing block of a broadcast cue sheet according to an embodiment of the present invention.

FIG. 13 is a flowchart illustrating an example of a method according to an embodiment of the present invention.

### DETAILED DESCRIPTION OF THE INVENTION

Hereinafter, specific details for the implementation of the present invention will be described in detail with reference to the attached drawings. However, in the following description, specific descriptions of widely known functions or configurations, which may unnecessarily obscure the subject matter of the present disclosure, will be omitted.

In the accompanying drawings, like or relevant components are indicated by like reference numerals. In addition, in the following description of embodiments, repeated descriptions of the identical or relevant components will be omitted. However, even if a description of a component is omitted, such a component is not intended to be excluded from an embodiment.

The advantages and features of the disclosed embodiments, and the methods for achieving them will become clear with reference to the embodiments described below together with the attached drawings. However, the present invention is not limited to the embodiments disclosed below, and may be implemented in various different forms, and the embodiments are provided only to make the present invention complete and to fully inform a person skilled in the art of the scope of the invention.

The terms used in this specification will be briefly explained, and then the disclosed embodiments will be described in detail. The terms used in this specification are selected from the most widely used general terms, considering the functions in the present invention. However, these may vary depending on the intentions of engineers in the related field, precedents, the emergence of new technologies, or the like. In addition, in certain cases, there are terms arbitrarily selected by the applicant, and in such cases, their meanings will be described in detail in the relevant description of the invention. Therefore, the terms used in the present disclosure should be defined based on the meaning of the terms and the overall content of the present disclosure, not simply the names of the terms.

In this specification, singular expressions include plural expressions unless the context clearly specifies that they are singular. In addition, plural expressions include singular expressions unless the context clearly specifies that they are plural. When a part includes a certain component throughout the specification, this indicates that the part may further include other components, unless otherwise specifically stated, instead of excluding other components.

In addition, the terms “module” or “part” used in the specification refer to software or hardware components, and “modules” or “parts” perform certain roles. However, a “module” or “part” is not limited to software or hardware. A “module” or “part” may be configured to reside on an addressable storage medium, and may be configured to execute on one or more processors. Accordingly, as an example, a “module” or “part” may include at least one of components, such as software components, object-oriented software components, class components, and task components, processes, functions, attributes, procedures, subroutines, segments of program code, drivers, firmware, microcode, circuits, data, databases, data structures, tables, arrays, or variables. The components and “modules” or “parts” may be combined into a smaller number of components and “modules” or “parts” or may be further divided into a larger number of components and “modules” or “parts” in relation to the functions provided therefrom.

According to an embodiment of the present invention, “module” or “part” may be implemented as a processor and a memory. A “processor” may be broadly construed to include a central processing unit (CPU), a microprocessor, a digital signal processor (DSP), a controller, a microcontroller, a state machine, or the like. In some circumstances, a “processor” may also refer to an application-specific integrated circuit (ASIC), a programmable logic device (PLD), a field programmable gate array (FPGA), or the like. A “processor” may also refer to a combination of processing devices, such as, a combination of a DSP and a microprocessor, a combination of a plurality of microprocessors, a combination of one or more microprocessors combined with a DSP core, or a combination of any other such configurations. In addition, a “memory” may be broadly construed to include any electronic component capable of storing electronic information. A “memory” may also refer to various types of processor-readable media, such as, a random-access memory (RAM), a read-only memory (ROM), a non-volatile random-access memory (NVRAM), a programmable read-only memory (PROM), an erasable programmable read-only memory (EPROM), an electrically erasable PROM (EEPROM), a flash memory, magnetic or optical data storage devices, registers, or the like. If a processor is capable of reading information from and/or write information to a memory, the memory is said to be in electronic communication with the processor. A memory integrated into the processor is in electronic communication with the processor.

In the present disclosure, a “system” may include at least one of a server device and a cloud device, but is not limited thereto. For example, the system may be configured as one or more server devices. As another example, the system may be configured as one or more cloud devices. As another example, the system may be configured as a combination of a server device and a cloud device, and may be operated.

In the present disclosure, a “display” may refer to any display device associated with a computing device, for example, any display device capable of being controlled by a computing device or displaying any information/data provided from a computing device.

In the present disclosure, “each of a plurality of As” or “each of the multiple As” may refer to each of all components included in the plurality of As, or may refer to each of some components included in the plurality of As.

A “machine learning model” may include any model used to infer an answer to a given input. According to an embodiment, the machine learning model may include an artificial neural network model that includes an input layer, a plurality of hidden layers, and an output layer. Here, each layer may include a plurality of nodes. In the present disclosure, although each of a plurality of machine learning models will be described as a separate machine learning model, the invention is not limited thereto, and some or all of the plurality of machine learning models may be implemented as one machine learning model. Additionally, one machine learning model may include a plurality of machine learning models. In the present disclosure, a machine learning model and an artificial neural network model may be used interchangeably to indicate the identical or similar models. In addition, a “language model” or “language generation model” in the present disclosure may refer to a machine learning model or an artificial neural network model configured to calculate the probability for a sequence of one or more words or at least a portion of a sentence, or to generate a sequence of words or a portion of a sentence.

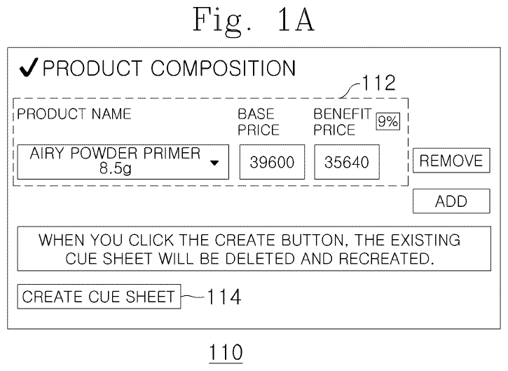

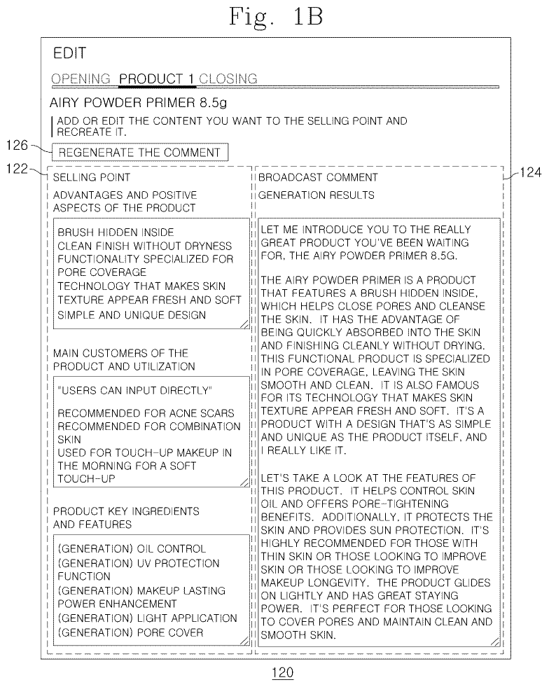

FIGS. 1A and 1B illustrate an example of a method for generating a broadcast cue sheet 124 according to an embodiment of the present invention. A first operation 110 and a second operation 120 illustrated in FIGS. 1A and 1B exemplify operations performed by a user through a user interface displayed on a display of a user terminal in order to generate a broadcast cue sheet.

Specifically, the first operation 110 exemplifies an operation in which the user inputs information 112 for specifying a product. The user may input information 112 for specifying a product to be introduced through a broadcast, such as live commerce, for the purpose of selling or advertising the product. Here, the information 112 for specifying a product may include a product name, a product number, a predetermined catalog ID associated with a product, and the like. Additionally, a cue sheet associated to a relevant product may be generated by the user clicking or selecting a “cue sheet generation” button 114.

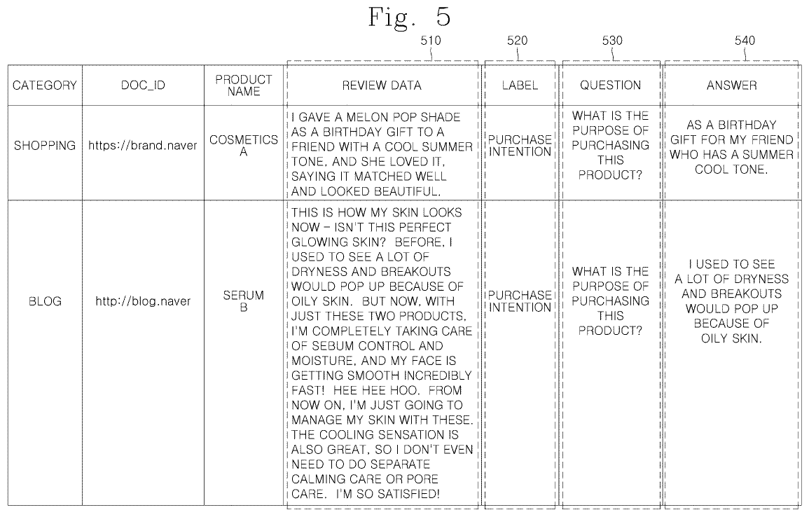

The second operation 120 exemplifies an operation in which the cue sheet 124 associated with a relevant product is generated and output. One or more keywords may be extracted from review data associated with the product specified by the user. In addition, a broadcast cue sheet may be generated from the extracted keywords. An example of a process of extracting the keywords will be described in detail with reference to FIG. 5 below.

In an embodiment, the keywords may be provided to the user as a selling point 122. Here, the selling point 122 may include the advantages of the product, the main customers and utilization methods of the product, the main ingredients and the features of the product, and the like. For example, as the advantages of the product, “brush hidden inside,” “clean finish without dryness,” or the like may be output as the selling point 122. In addition, as the main customers and the utilization methods of the product, “recommended for acne scars,” “recommended for combination skin,” or the like may be output as the selling point 122. In addition, as the main ingredients and features of the product, “oil control,” “UV protection function,” or the like may be output as the selling point 122. If there is no appropriate keyword that may be provided as the selling point 122, a selling point may be generated by the user directly inputting a keyword, or from review data of other products similar to the product using a language model.

In an embodiment, a broadcast cue sheet 124 may be generated based on one or more keywords using a language generation model. Specifically, a bullet-point short sentence or a phrase including one or more keywords may be generated. Here, the bullet-point short sentence may include a short sentence combining one or more keywords and nouns associated with a relevant product, or a short sentence combining one or more keywords and adjectives associated with the product. In addition, a long sentence, which is a grammatically complete sentence, may be generated by adding sentence components to the bullet-point short sentence, enabling the meaning of the broadcast cue sheet to be conveyed. In addition, the broadcast cue sheet 124 may be generated based on a prompt associated with the composition of the broadcast cue sheet and the generated long sentence.

In an embodiment, the user may regenerate a cue sheet by clicking or selecting a “comment regeneration” button 126. Specifically, the user may modify a keyword of the automatically generated selling point 122. In this case, the user may be provided with a new cue sheet generated based on the modified keyword through the “comment regeneration” button 126. Additionally or alternatively, the user may directly modify the automatically generated cue sheet 124. Additionally or alternatively, the user may be provided with a new cue sheet through the “comment regeneration” button 126 even without modifying the selling point 122 and the cue sheet 124.

A method of the present invention may be applied to various fields as well as broadcast cue sheets. For example, a method of generating a script such as a cue sheet using a language generation model of the present invention may be applicable to fields for writing other types of long sentences such as speeches, announcements, curator scripts, narration scripts, movie scripts, or the like, which require text structured based on specific topics or keywords. Thus, the present invention may be applicable to various services such as speeches, presentations, docents, curators, narrations, and TTS-based virtual avatars, virtual humans, videos, short forms, and video subtitle generation, or the like. In addition, the present invention may be used for a method of collecting materials and data for creative activities such as writing articles, and may be utilized for draft writing.

With the present invention, the user may be conveniently provided with broadcast cue sheets by simply entering information for specifying a product. In addition, users may easily reflect their intentions in the broadcast cue sheet by modifying the automatically generated keywords or cue sheets. Accordingly, the time and cost required to create a broadcast cue sheet may be significantly reduced.

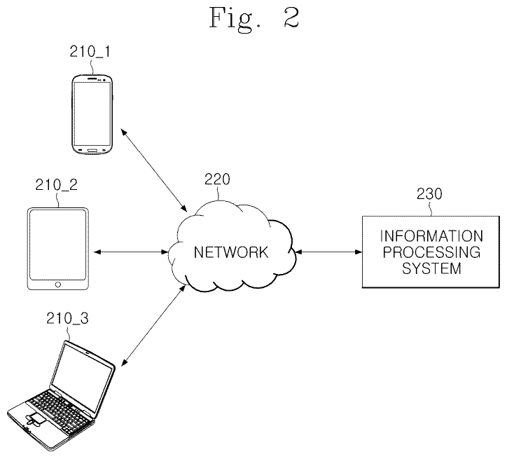

FIG. 2 is a schematic diagram illustrating a configuration in which an information processing system 230 is connected to a plurality of user terminals 210_1, 210_2, 210_3 to be able to communicate with each other in order to generate a broadcast cue sheet according to an embodiment of the present invention. As illustrated, a plurality of user terminals 210_1, 210_2, 210_3 may be connected to an information processing system 230 capable of providing a broadcast cue sheet generation service through a network 220. The plurality of user terminals 210_1, 210_2, 210_3 may include terminals of users who receive a broadcast cue sheet generation service.

In an embodiment, the information processing system 230 may include one or more server devices and/or databases capable of storing, providing, and executing computer-executable programs (e.g., downloadable applications) and data associated with provision of the broadcast cue sheet generation service, or one or more distributed computing devices and/or distributed databases based on cloud computing services therefor.

The broadcast cue sheet generation service provided by the information processing system 230 may be provided to the user through a broadcast cue sheet generation service application web browser or web browser extension program installed on each of the plurality of user terminals 210_1, 210_2, 210_3. For example, the information processing system 230 may provide information corresponding to a broadcast cue sheet generation request received from the user terminals 210_1, 210_2, 210_3 or perform a process corresponding thereto through a broadcast cue sheet generation service application.

The plurality of user terminals 210_1, 210_2, 210_3 may communicate with the information processing system 230 through the network 220. The network 220 may be configured to enable communication between the plurality of user terminals 210_1, 210_2, 210_3 and the information processing system 230. The network 220, depending on the installation environment, may be configured as, for example, a wired network such as Ethernet, a wired home network (power line communication), a telephone line communication device, and RS-serial communication, a wireless network such as a mobile communication network, a

WLAN (Wireless LAN), Wi-Fi, Bluetooth, and ZigBee, or a combination thereof. The communication method is not limited thereto, and may include not only a communication method utilizing the communication network (e.g., mobile communication network, wired Internet, wireless Internet, broadcasting network, satellite network, or the like) included in the network 220, but also short-range wireless communication among the user terminals 210_1, 210_2, 210_3.

Although a mobile phone terminal 210_1, a tablet terminal 210_2, and a PC terminal 210_3 are illustrated as examples of the user terminals in FIG. 2, they are not limited thereto, and the user terminals 210_1, 210_2, 210_3 may be any computing device capable of wired and/or wireless communication and capable of installing and executing a broadcast cue sheet generation service application or web browser. For example, the user terminals 210_1, 210_2, 210_3 may include an AI speaker, a smartphone, a mobile phone, a navigation device, a computer, a laptop computer, a digital broadcasting terminal, a PDA (Personal Digital Assistants), a PMP (Portable Multimedia Player), a tablet PC, a game console, a wearable device, an IoT (internet of things) device, a VR (virtual reality) device, an AR (augmented reality) device, a set-top box, or the like. In addition, although FIG. 2 illustrates that three user terminals 210_1, 210_2, 210_3 communicate with the information processing system 230 through the network 220, the invention is not limited thereto, and a different number of user terminals may be configured to communicate with the information processing system 230 through the network 220.

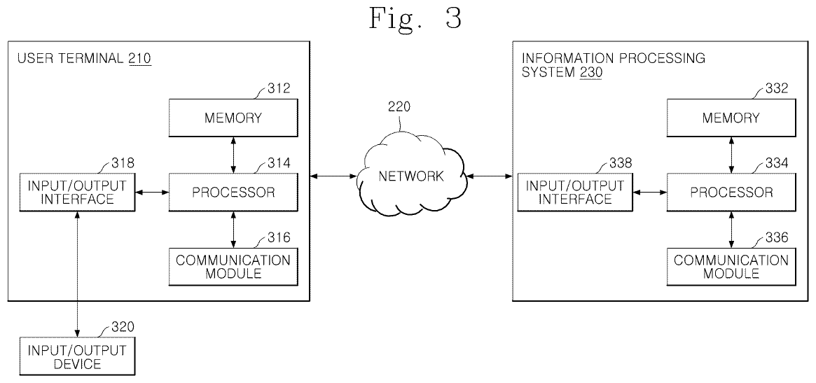

FIG. 3 is a block diagram illustrating the internal configuration of a user terminal 210 and an information processing system 230 according to an embodiment of the present invention. The user terminal 210 may refer to any computing device capable of executing an application, a web browser, etc. and capable of wired/wireless communication, and may include, for example, the mobile phone terminal 210_1, the tablet terminal 210_2, and the PC terminal 210_3 shown in FIG. 2. As illustrated, the user terminal 210 may include a memory 312, a processor 314, a communication module 316, and an input/output interface 318. Similarly, the information processing system 230 may include a memory 332, a processor 334, a communication module 336, and an input/output interface 338. As illustrated in FIG. 3, the user terminal 210 and the information processing system 230 may be configured to share information and/or data through the network 220 using their own communication modules 316 and 336. In addition, an input/output device 320 may be configured to input information and/or data to the user terminal 210 or to output information and/or data generated from the user terminal 210 through the input/output interface 318.

The memory 312 or 332 may include any non-transitory computer-readable recording medium. According to an embodiment, the memory 312 or 332 may include a permanent mass storage device such as a ROM (read-only memory), a disk drive, an SSD (solid-state drive), a flash memory, or the like. As another example, a permanent mass storage device such as a ROM, an SSD, a flash memory, a disk drive, or the like may be included in the user terminal 210 or the information processing system 230 as a separate permanent storage device distinct from the memory 312 or 332. In addition, the memory 312 or 332 may store an operating system and at least one program code.

These software components may be loaded from a computer-readable recording medium separate from the memory 312 or 332. The separate computer-readable recording medium may include a recording media capable of being directly connected to the user terminal 210 and the information processing system 230, for example, a computer-readable recording medium such as a floppy drive, a disk, a tape, a DVD/CD-ROM drive, a memory card, or the like. As another example, software components may be loaded into the memory 312 or 332 through the communication module 316 or 336 other than a computer-readable recording medium. For example, at least one program may be loaded into the memory 312 or 332 on the basis of a computer program that is installed in files provided by developers or a file distribution system that distributes application installation files through the network 220.

The processor 314 or 334 may be configured to process commands of a computer program by performing basic arithmetic, logic, and input/output operations. Commands may be provided to the processor 314 or 334 by the memory 312 or 332 or the communication module 316 or 336. For example, the processor 314 or 334 may be configured to execute a received command according to a program code stored in the storage device such as the memory 312 or 332.

The communication module 316 or 336 may provide a configuration or function for the user terminal 210 and the information processing system 230 to communicate with each other through the network 220, and may provide a configuration or function for the user terminal 210 and/or the information processing system 230 to communicate with another user terminal or another system (e.g., separate cloud system or the like). For example, a request or data (e.g., a broadcast cue sheet generation request or the like) generated by the processor 314 of the user terminal 210 according to a program code stored in a recording device such as the memory 312 may be transmitted to the information processing system 230 through the network 220 under the control of the communication module 316. Conversely, a control signal or command provided according to the control of the processor 334 of the information processing system 230 may be received by the user terminal 210 through the communication module 316 of the user terminal 210 via the communication module 336 and the network 220.

The input/output interface 318 may be a means for interfacing with the input/output device 320. As an example, the input device of the input/output device 320 may include a device such as a camera including an audio sensor and/or an image sensor, a keyboard, a microphone, and a mouse, and the output device of the input/output device 320 may include a device such as a display, a speaker, and a haptic feedback device. As another example, the input/output interface 318 may be a means for interfacing with a device, such as a touch screen, in which configurations or functions for performing input and output are integrated into one. For example, when the processor 314 of the user terminal 210 processes a computer program command loaded into the memory 312, a service screen configured using information and/or data provided from the information processing system 230 or another user terminal may be displayed on the display through the input/output interface 318. Although FIG. 3 illustrates the input/output device 320 that is not included in the user terminal 210, it is not limited thereto, and the input/output device 320 may be configured as a single device with the user terminal 210. In addition, the input/output interface 338 of the information processing system 230 may be a means for interfacing with a device (not illustrated) for input or output, which is connected to the information processing system 230 or included in the information processing system 230. Although FIG. 3 illustrates the input/output interface 318 or 338 as an element configured separately from the processor 314 or 334, it is not limited thereto, and the input/output interface 318 or 338 may be configured to be included in the processor 314 or 334.

The user terminal 210 and the information processing system 230 may include more components than the components shown in FIG. 3. For example, the user terminal 210 may be implemented to include at least a part of the input/output device 320 described above. In addition, the user terminal 210 may further include other components such as a transceiver, a GPS (Global Positioning System) module, a camera, various sensors, a database, and the like. In a case where the user terminal 210 is a smartphone, components generally included in a smartphone may be included. For example, various components such as an acceleration sensor, a gyro sensor, a microphone module, a camera module, various physical buttons, buttons using a touch panel, input/output ports, and a vibrator for vibration may be further included in the user terminal 210.

While the program for the broadcast cue sheet generation service application is running, the processor 314 may receive text, images, videos, voices, and/or motions input or selected through an input device connected to the input/output interface 318 such as a touch screen, a keyboard, a camera including an audio sensor and/or an image sensor, or a microphone, and may store the received text, images, videos, voices, and/or motions in the memory 312 or provide the same to the information processing system 230 through the communication module 316 and the network 220.

The processor 314 of the user terminal 210 may be configured to manage, process and/or store information and/or data received from the input/output device 320, another user terminal, the information processing system 230, and/or a plurality of external systems. Information and/or data processed by the processor 314 may be provided to the information processing system 230 through the communication module 316 and the network 220. The processor 314 of the user terminal 210 may transmit information and/or data to the input/output device 320 through the input/output interface 318, thereby outputting the same. For example, the processor 314 may display the received information and/or data on a screen of the user terminal 210.

The processor 334 of the information processing system 230 may be configured to manage, process, and/or store information and/or data received from a plurality of user terminals 210 and/or a plurality of external systems. Information and/or data processed by the processor 334 may be provided to the user terminal 210 through the communication module 336 and the network 220.

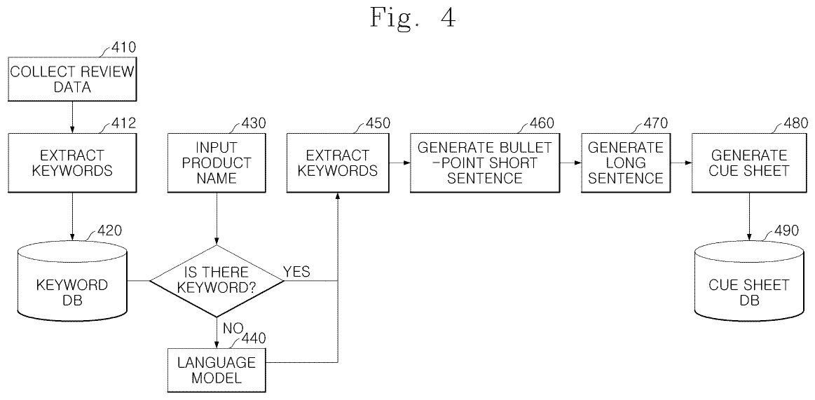

FIG. 4 is a diagram illustrating a method for generating a cue sheet according to an embodiment of the present invention. In an embodiment, review data of a product sold by a seller with broadcasting rights may be collected from blogs, shopping malls, and the like 410. In addition, one or more keywords with a high frequency may be extracted from the review data associated with the selling product 412. In this case, the extracted keywords may be stored in a keyword database 420.

In an embodiment, a user input including information (e.g., product name or the like) for specifying a product may be received 430. In a case where a keyword associated with the relevant product is stored in the keyword database 420, the keyword stored in the database 420 may be extracted 450. On the other hand, in a case where a keyword associated with the product does not exist in the keyword database 420, a keyword 450 may be extracted from review data of another product similar to the relevant product using a language model 440. Alternatively, the user may directly input a keyword associated with the product.

In an embodiment, a bullet-point short sentence 460 may be generated based on the extracted keyword. Here, the bullet-point short sentence may include a short sentence or phrase combining one or more keywords and nouns associated with the product, or a short sentence combining one or more keywords and adjectives associated with the product. In this case, the nouns and/or adjectives associated with the combined product may be combined before and after the keyword. In addition, predetermined forbidden words that are not allowed in broadcasts may be removed from the bullet-point short sentence.

In an embodiment, a long sentence may be generated based on the bullet-point short sentence 470. Here, a long sentence may indicate a sentence obtained by adding sentence components to the bullet-point short sentence, enabling the meaning of the broadcast cue sheet to be conveyed. That is, the long sentence may be a grammatically complete sentence generated from the bullet-point short sentence. In addition, a long sentence reflecting the writing style of a show host may be generated.

In an embodiment, a broadcast cue sheet may be generated based on the long sentence and prompts associated with the configuration of the broadcast cue sheet 480. Here, the prompts may include information associated with at least one of an opening block, a body block, or a closing block. In addition, a script may be generated by adding broadcast comments to the generated long sentence according to the configuration corresponding to the prompts. A cue sheet may be completed by combining the multiple scripts above. In addition, the generated cue sheet may be stored in a cue sheet database 490.

All or some of the respective procedures of the cue sheet generation method described above may be executed by a machine learning model, a language model, a language generation model, or a user associated with the generation of the broadcast cue sheet.

FIG. 5 is a diagram illustrating an example of extracting keywords from review data 510 according to an embodiment of the present invention. In an embodiment, review data 510 may be collected from shopping malls, blogs, Internet cafes, Internet news, and company homepages associated with the relevant product in response to information for specifying a product (e.g., product name, product number, catalog ID, etc.) from the user. In addition, the review data 510 may include not only general text but also text converted from voices included in review videos posted on the Internet. For example, if a user specifies “cosmetics A,” review data associated with the product such as “I gave a Melon Pop shade as a birthday gift to a friend with a cool summer tone, and she loved it, saying it matched well and looked beautiful” may be collected.

In an embodiment, the review data 510 may be informational review data collected by filtering out spam/promotional review data from the entire review data. Here, informational review data may refer to review data that includes actual user review information on various features of the product. In addition, only review data generated within a predetermined period (e.g., within the last year) may be collected from the review data.

In an embodiment, the review data 510 may be preprocessed by identifying whether the collected review data 510 includes answers to at least some of the predetermined multiple questions 530 using a machine learning model. Specifically, it may be determined whether answer data corresponding to at least some of the predetermined multiple questions 530 is able to be extracted from the review data 510 through a question semantic matcher (QSM) model. Here, the question semantic matcher model may be a machine learning model that learns a set of document data (or review data), question data, and answer data and determines whether an answer corresponding to the question data exists in the document data. In addition, the predetermined multiple questions 530 may be questions related to the intended users of the product, the intention to purchase the product, the advantages of the product, the disadvantages of the product, the purchase history/plan, the related products/brands mentioned with the product, the place of purchase of the product, the product awareness channel, the composition/application technology of the product, the appearance of the product, the nickname of the product, the method of utilizing the product, the collaboration/planning of the product, and the like.

In an embodiment, if the review data 510 includes answers to at least some of the predetermined multiple questions 530, answer data corresponding to at least some of the predetermined multiple questions 530 may be extracted from the review data 510 using a language model. Here, the language model for generating the answer data may be learned using a predetermined learning data set.

Specifically, a set of question data and document data may be input to a first generative model. In this case, the first generative model may pseudo-label at least some of the document data as first answer data for specific questions within the question data. Here, the first answer data may include inappropriate noise answers for specific questions. To reduce the noise answers, a second generative model may be further used. Specifically, some of the first answer data may be inspected, and noise may be removed therefrom. For example, the inspection of the answer data may be manually performed by an operator of the system. Accordingly, the inspected answer data may be considered as correct data. Here, for the efficiency of the inspection, it is not necessary to inspect all of the first answer data. In addition, the second generative model may be trained using specific questions corresponding to the first answer data and the inspected answer data. After that, by inputting the remaining part of the first answer data that has not been inspected into the second generative model, the second generative model may label the corresponding part of the first answer data as the second answer data. Using the second generative model trained as described above, answer data may be generated from the review data 510.

In an embodiment, the answer data may undergo a post-processing process such as removing duplicate sentences from the answer data, removing sentences in an inclusion relationship from the answer data, or removing sentences that are different from the original review data. In addition, by clustering similar answer data into at least one group, a representative keyword 540 of each of one or more groups may be extracted. In this case, a representative keyword 540 may be determined based on the frequency of keywords included in at least one group in the review data. For example, a representative keyword 540 “as a birthday gift for a friend with a cool summer tone” may be extracted from the review data 510 in response to a question 530 “What is the purpose of purchasing this product?” in relation to the purchase intention for “cosmetics A.”

Through this configuration, the user may easily identify the review keywords of the product by simply entering information for specifying the product. In addition, through the preprocessing and postprocessing of the answer data generated for the question associated with the product, the uncertainty in the subsequent keyword extraction step may be reduced, thereby improving the reliability of the review keywords.

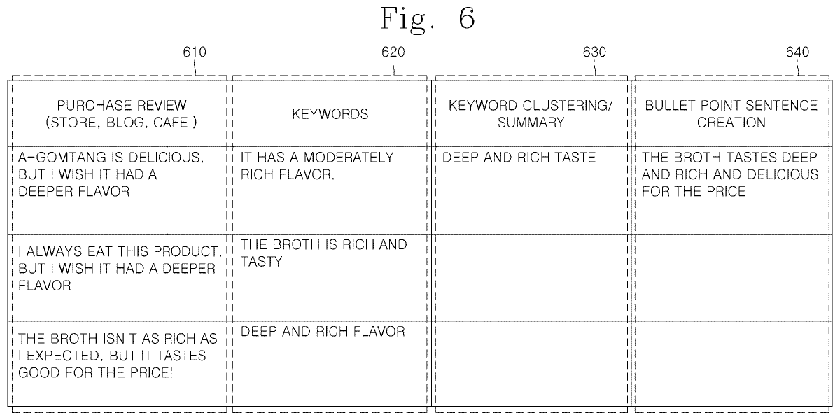

FIG. 6 is a diagram illustrating an example of generating bullet-point short sentences from keywords according to an embodiment of the present invention. In an embodiment, keywords 620 extracted from review data 610 may be clustered. Specifically, each keyword 620 may be converted into an embedding vector by a machine learning model. In addition, the embedding vectors may be clustered into at least one group on the basis of the distance between the embedding vectors. For example, multiple embedding vectors may be clustered through a K-means algorithm, but the present invention is not limited thereto.

In an embodiment, representative keywords 630 may be extracted from at least one group, respectively. Here, the representative keyword 630 may be determined based on the frequency of the keyword 620 included in at least one group. For example, if the keywords 620 of a clustered group are “It has a moderately rich flavor,” “The broth is rich and tasty,” and “deep and rich flavor,” the representative keyword 630 may be determined as “deep and rich taste” on the basis of the frequency of the keyword 620.

In an embodiment, a bullet-point short sentence 640 may be generated based on the representative keyword 630. Here, the bullet-point short sentence may include a short sentence combining a keyword and nouns associated with the product, or a short sentence combining a keyword and adjectives associated with the product. For example, if the product is “Gomtang” and the representative keyword is “deep and rich flavor,” a bullet-point short sentence “The broth tastes deep, rich, and delicious for the price” may be generated. In addition, the bullet-point short sentence may include a short sentence combining a keyword and a timely short sentence. For example, a bullet-point short sentence “The broth tastes deep, rich, and delicious—perfect for a cold winter day” may be generated. In addition, predetermined forbidden words may be removed from the bullet-point short sentence.

The sentence may be processed more appropriately by first generating short sentences, instead of directly generating long sentences for the broadcast cue sheet from the keywords. In addition, by filtering out forbidden words or the like from short sentences before generating a long sentence, it is possible to prevent the long sentence that is not suitable for broadcasting from being generated.

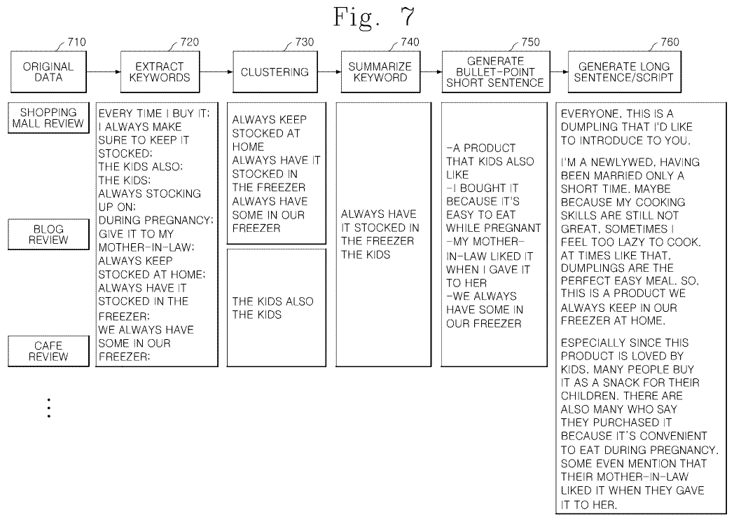

FIG. 7 is a diagram illustrating an example of generating a broadcast cue sheet according to an embodiment of the present invention. In an embodiment, original review data associated with a product (e.g., “dumpling A”) may be collected from online shopping malls, blogs, and the like (710). In addition, one or more keywords may be extracted from the original review data (720). In addition, one or more keywords may be clustered based on the similarity between one or more keywords (730). In this case, by summarizing keywords included in the clustered groups, a representative keyword may be extracted from each group (740). For example, a representative keyword “always have it stocked in the freezer” may be extracted from a group including keywords such as “always keep stocked at home,” “always have it stocked in the freezer,” and “always in the freezer.”

In an embodiment, a bullet-point short sentence may be generated based on the representative keyword (750). Specifically, a bullet-point short sentence may be generated by combining nouns or adjectives associated with the product with the representative keyword. In addition, a bullet-point short sentence may be generated by processing the representative keyword to be suitable for a live commerce broadcast. For example, in a case where the representative keyword is “always stocked in the freezer,” a bullet-point short sentence “always in our freezer” may be generated. As another example, if the representative keyword is “kids,” a bullet-point short sentence “a product that kids also like” may be generated.

In an embodiment, a long sentence and a cue sheet may be generated based on the bullet-point short sentence (760). Specifically, a long sentence may be generated by adding sentence components to the bullet-point short sentence, enabling the meaning of the broadcast cue sheet to be conveyed. Here, the sentence components may include a subject, an object, an adverb, a predicate, and the like. For example, if the bullet-point short sentence is “always have it stocked in the freezer,” a long sentence such as “This is a product we always keep in our freezer at home” may be generated. As another example, if the bullet-point short sentence is “a product that kids also like,” a long sentence such as “Especially since this product is loved by kids, many people buy it as a snack for their children” may be generated. In addition, the writing style of the show host may be reflected in the generated long sentence by the machine learning model.

In an embodiment, a broadcast cue sheet may be generated based on the long sentence. In this case, a prompt associated with the composition of the broadcast cue sheet may be further required. Here, the prompt may include information related to at least one of the opening block, the body block, or the closing block.

In an embodiment, the composition of the cue sheet may be structured using the labels of keywords extracted from the review data. For example, the composition of the cue sheet may include a product introduction composition based on keywords associated with the advantages and nicknames of the product, a product introduction composition based on keywords associated with the product utilization, purchase intention, and intended users, and a product introduction composition associated with the key ingredients and appearance of the product. Under this composition, the composition of the cue sheet may be effectively conveyed according to the category.

Through this configuration, a long sentence capable of conveying meaning may be generated from the bullet-point short sentence generated from the keyword associated with the product. In addition, by segmenting and modularizing the cue sheet into blocks using prompts, a broadcast cue sheet with a natural context and composition may be created. In addition, by generating the cue sheet using keywords labeled based on predetermined questions, the composition of the cue sheet may be structured, and the content of the cue sheet may be effectively conveyed.

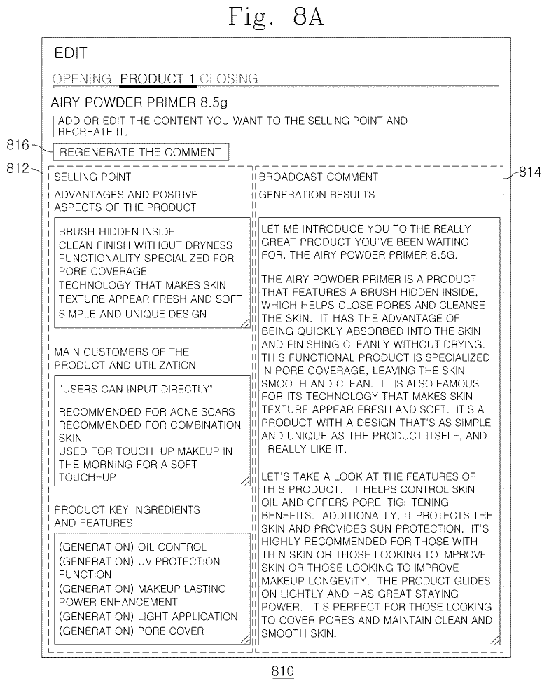

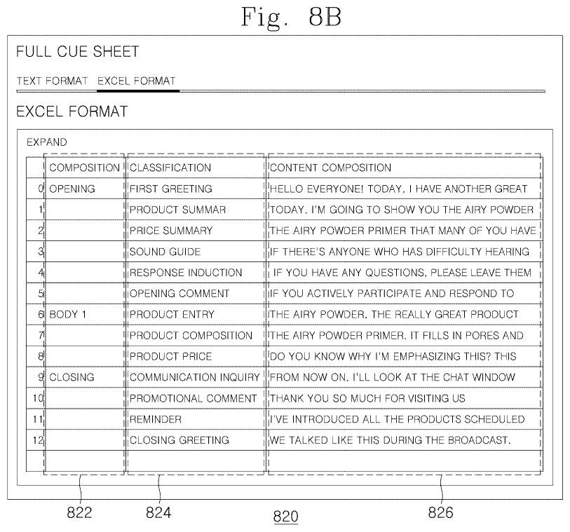

FIGS. 8A and 8B are diagrams illustrating an example of a broadcast cue sheet 814 according to an embodiment of the present invention. A first operation 810 and a second operation 820 illustrated in FIGS. 8A and 8B are examples of operations in which a broadcast cue sheet is output through a user interface displayed on the display of a user terminal 210.

Specifically, the first operation 810 is an example in which a broadcast cue sheet 814 generated according to the present invention is output. By specifying a product (e.g., “airy powder primer 8.5 g”), the user may identify a selling point 812 and a cue sheet 814 generated based on review data of the product from the display of the user terminal 210.

In an embodiment, the selling point 812 may include advantages of the product, main customers and utilization methods of the product, main ingredients and features of the product, and the like. For example, as the advantages of the product, “brush hidden inside,” “clean finish without dryness,” or the like may be output as the selling point 812, and as the main customers and the utilization methods of the product, “recommended for acne scars,” “recommended for combination skin,” or the like may be output as the selling point 812, and as the main ingredients and features of the product, “oil control,” “UV protection function,” or the like may be output as the selling point 812. If there is no appropriate keyword as the selling point 812, a selling point may be generated by the user directly inputting a keyword, or from review data of other products similar to the product using a language model.

In an embodiment, a broadcast cue sheet 814 may be generated based on keywords extracted from review data using a language generation model. In this case, the broadcast cue sheet 814 may include paragraphs corresponding to the opening block, the body block, and the closing block. In addition, the writing style of a show host may be reflected in the broadcast cue sheet 814. Additionally, the cue sheet 814 may include a conversation format of two or more speakers.

In an embodiment, the user may regenerate a cue sheet by clicking and selecting a “comment regeneration” button 816. Specifically, the user may modify the keywords of the selling point 812 or input mandatory keywords that must be included in the cue sheet. In this case, the user may be provided with a cue sheet updated based on the keywords modified through the “comment regeneration” button 816 or the mandatory keywords. Additionally or alternatively, the user may directly modify the cue sheet 814.

In an embodiment, the cue sheet 814 may be updated to reflect the features of the speaker. If the user inputs personal information (e.g., age, gender, specialty, etc.) of a show host, the cue sheet may be updated to include expressions suitable for the show host by reflecting the personal information of the show host. For example, if the personal information of the show host is input as “a woman in her 40s with a child,” expressions that resonate with those raising a child may be reflected in the cue sheet. In addition, based on the type of product and the cue sheet 814, a show host suitable for live commerce broadcasting may be recommended from a show host database. Additionally, a voice of the show host pronouncing the broadcast cue sheet 814 may be generated using a voice synthesis model.

The second operation 820 is an example showing the detailed composition of the broadcast cue sheet in a table format. The cue sheet composition 822 may be divided into an opening block, at least one body block, and a closing block. In addition, each block may include classifications 824 and content compositions 826 corresponding to the classifications 824. For example, the opening block may include classifications such as a first greeting, a product summary, a price summary, a sound guide, a response induction, and an opening comment, and the body block may include classifications such as a product entry, a product composition, and a product price, and the closing block may include classifications such as a communication inquiry, a promotional comment, a reminder, and a closing greeting. In addition, content compositions 826 according to the classifications 824 may be respectively written for the classifications 824. The user may identify and modify the content compositions 826 according to the classifications 824.

With this configuration, the user may easily understand the content of the broadcast cue sheet by identifying the overall compositions of the broadcast cue sheet. In addition, the user may use a more complete cue sheet by modifying the content of the broadcast cue sheet generated by the language generation model. Additionally, the user may effectively rehearse the live commerce broadcast by playing the voice synthesis result of the cue sheet reflecting the speech style of the show host.

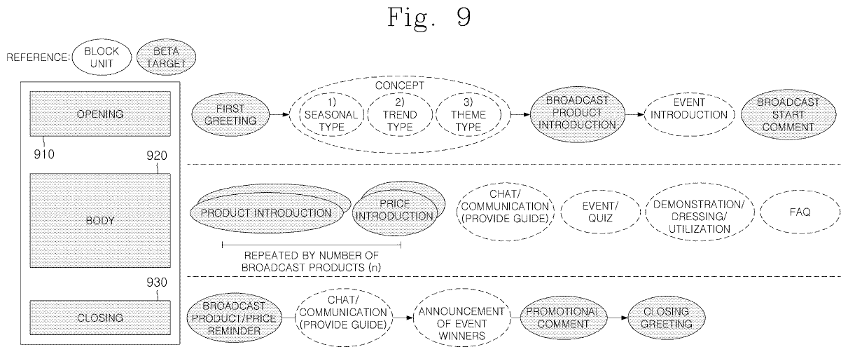

FIG. 9 is a diagram illustrating an example of a broadcast cue sheet composition according to an embodiment of the present invention. As illustrated, the broadcast cue sheet may include an opening block 910, a body block 920, and a closing block 930. In addition, each block may include detailed compositions. For example, the opening block 910 may include detailed compositions such as a first greeting, a concept (e.g., seasonal, trendy, theme-type, etc.), a broadcast product introduction, an event introduction, and a broadcast start comment. In addition, the body block 920 may include detailed compositions such as introduction of at least one product and price introduction, communication guidelines with viewers, events, product demonstrations, and answers to inquiries. Additionally, the closing block 930 may include detailed compositions such as broadcast product and price reminders, communication guidelines with viewers, announcements of event winners, product promotion comments, and closing greetings.

In an embodiment, a broadcast cue sheet may be generated based on prompts associated with the composition or detailed composition of the cue sheet. For example, if a prompt associated with the opening block is input into the language generation model, a script corresponding to the opening block may be generated. As another example, if a prompt associated with a product introduction composition of the body block is input into the language generation model, a script corresponding to the product introduction composition of the body block may be generated.

The compositions of the cue sheet illustrated in FIG. 9 are only an example and are not limited thereto. Some compositions may be deleted or new compositions may be added depending on the broadcast time. In addition, the order of the cue sheet compositions may be changed by changing the input order of the prompts. Additionally, by entering the expected broadcast time in the prompt, a script of an appropriate length for the expected broadcast time may be generated.

With this configuration, the compositions of the broadcast cue sheet may be subdivided/modularized into block units. Accordingly, the content of the respective blocks composing the cue sheet may be written more smoothly, and the overall composition of the cue sheet may be naturally connected. In addition, the composition of the cue sheet may be flexibly adjusted according to the prompt input by the user.

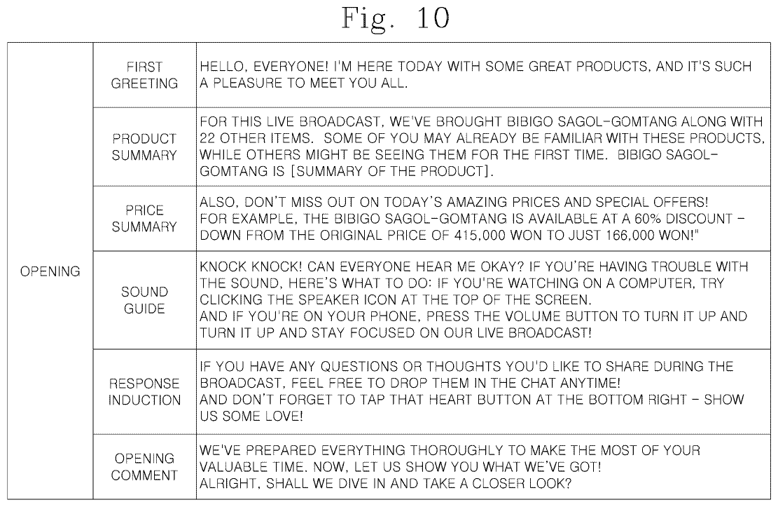

FIG. 10 is a diagram illustrating an example of an opening block of a broadcast cue sheet according to an embodiment of the present invention. In an embodiment, the opening block may include a “first greeting” part that initiates the broadcast. In addition, the opening block may include a “product summary” and a “price summary” part that summarize the product and the price of the product. In this case, the basic price and the discounted price among the prices of the product may be the prices input by the user. In addition, the opening block may include a “sound guide” part that prompts the viewer to check the volume of the device on which the broadcast is viewed. In addition, the opening block may include a “response induction” part that induces a response from viewers by utilizing the characteristics of a live commerce broadcast, and an “opening comment” part that initiates the broadcast.

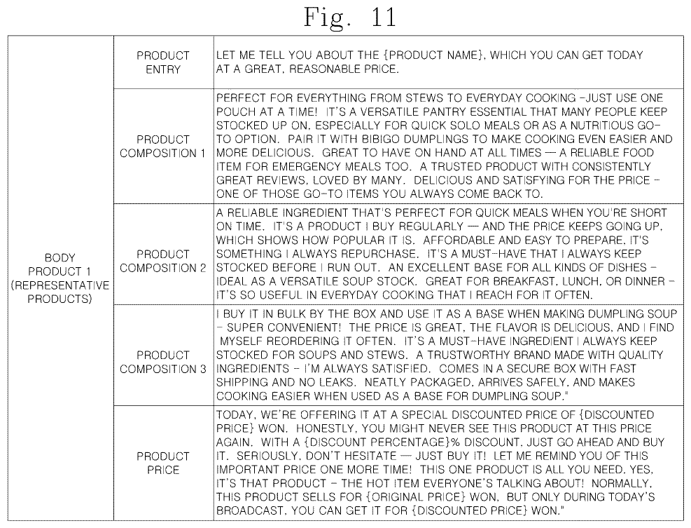

FIG. 11 is a diagram illustrating an example of a body block of a broadcast cue sheet according to an embodiment of the present invention. In an embodiment, the body block may include a “product entry” part that mentions the name of a product for sale. In addition, the body block may include at least one “product composition” part that introduces a product by type of product. In this case, the comment included in the “product composition” part may be a sentence generated based on review data. Additionally, a “product price” part that informs of the existing price and discounted price of the product.

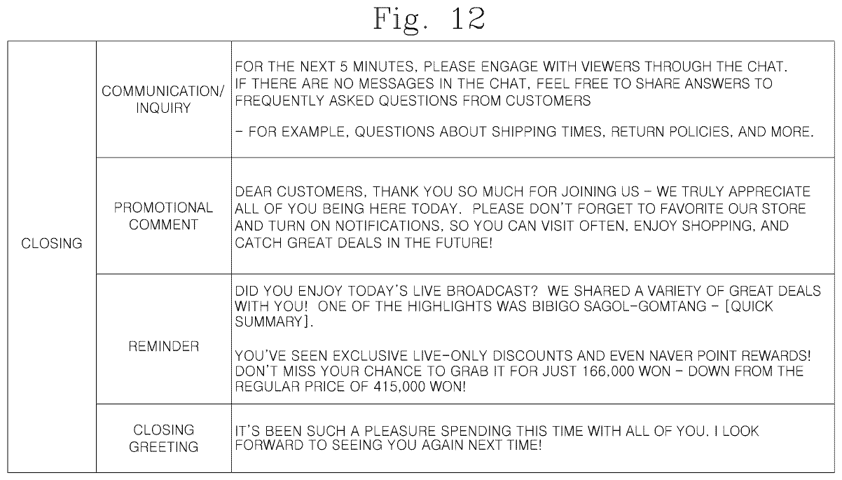

FIG. 12 is a diagram illustrating an example of a closing block of a broadcast cue sheet according to an embodiment of the present invention. In an embodiment, the closing block may include a “communication/question” part that guides questions and answers or communication with viewers. In addition, the closing block may include a “promotional comment” part that promotes the live commerce broadcast to viewers. Additionally, the closing block may include a “reminder” part that summarizes the content of the broadcast. Finally, the closing block may include a “closing greeting” part that concludes the broadcast and greets viewers.

The compositions of the cue sheet illustrated in FIGS. 10 to 12 are only an example and are not limited thereto. For example, depending on the type of product, broadcast time, etc., new compositions may be added, some of the compositions may be deleted, or the sequence of the compositions may vary.

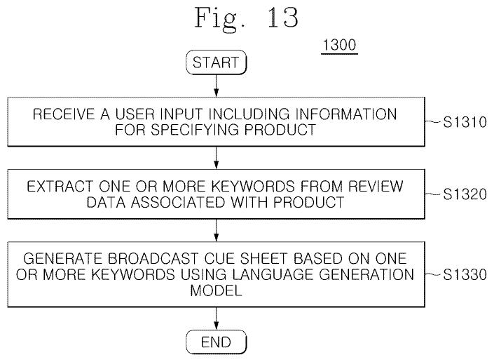

FIG. 13 is a flowchart illustrating an example of a method 1300 for generating a broadcast cue sheet according to an embodiment of the present invention. In an embodiment, the method 1300 may be performed by the processor 334. The method 1300 may be initiated by the processor 334 receiving a user input including information for specifying a product (S1310).

Thereafter, the processor 334 may extract one or more keywords from review data associated with the product (S1320). Specifically, the processor 334 may generate at least one piece of answer data from at least some of the review data on the basis of a plurality of predetermined questions using a language model. In addition, based on at least one piece of answer data, the processor 334 may extract review keywords associated with the product.

Thereafter, the processor 334 may generate a broadcast cue sheet on the basis of one or more keywords using a language generation model (S1330). Specifically, the processor 334 may generate a bullet-point short sentence including one or more keywords. In addition, the processor 334 may generate a long sentence on the basis of the bullet-point short sentence. Additionally, the processor 334 may receive a prompt associated with the composition of the broadcast cue sheet. Here, the prompt may include information associated with at least one of an opening block, a body block, or a closing block. In addition, the processor 334 may generate a broadcast cue sheet on the basis of the long sentence and the prompt.

In an embodiment, the processor 334 may convert answer data for a plurality of predetermined questions into embedding vectors. In addition, the processor 334 may generate at least one group on the basis of the distance between the embedding vectors. Additionally, the processor 334 may extract a representative keyword from each of one or more groups. In this case, the processor 334 may determine the representative keyword on the basis of the frequency of keywords included in at least one group in the review data.

In an embodiment, the processor 334 may remove predetermined forbidden words from the bullet-point short sentence. Here, the bullet-point short sentence may include a short sentence combining one or more keywords and nouns associated with the product or a short sentence combining one or more keywords and adjectives associated with the product. Additionally or alternatively, the bullet-point short sentence may include a short sentence combining one or more keywords and a timely short sentence.

In an embodiment, the processor 334 may generate a long sentence by adding sentence components to the bullet-point short sentence, enabling the meaning of the broadcast cue sheet to be conveyed. In addition, the processor 334 may generate a long sentence reflecting the writing style of a show host on the basis of the bullet-point short sentence using a machine learning model.

In an embodiment, the processor 334 may output at least one of the one or more keywords or the broadcast cue sheet. In addition, the processor 334 may modify one or more keywords in response to a user input for modifying one or more keywords. In this case, the processor 334 may update the broadcast cue sheet on the basis of one or more modified keywords.

In an embodiment, the processor 334 may generate the voice of the show host from the broadcast cue sheet using a speech synthesis model. In addition, the processor 334 may update the broadcast cue sheet on the basis of personal information of the show host in response to a user input associated with the personal information of the show host.

The above-described method may be provided as a computer program stored on a computer-readable recording medium for execution on a computer. A medium may be a medium that continuously stores a computer-executable program, or temporarily stores it for execution or download. In addition, a medium may be a variety of recording means or storage means in the form of a single piece of hardware or a combination of multiple pieces of hardware, and may not be limited to a medium directly connected to a computer system, but may also be distributed on a network. Examples of a medium include a magnetic medium such as a hard disk, a floppy disk, and a magnetic tape, an optical recording medium such as a CD-ROM and a DVD, a magneto-optical medium such as a floptical disk, a ROM, a RAM, a flash memory, or the like, which are configured to store program instructions. In addition, another example of a medium may include a record medium or storage medium managed by App store that distribute applications, or other sites and servers that supply or distribute various software.

The methods, operations, or techniques of the present invention may be implemented by various means. For example, these techniques may be implemented by hardware, firmware, software, or a combination thereof. The person skilled in the art will appreciate that the various exemplary logical blocks, modules, circuits, and algorithm steps described in connection with the disclosure of the present invention may be implemented by electronic hardware, computer software, or a combination of both. To clearly illustrate the interchangeability of hardware and software, various exemplary components, blocks, modules, circuits, and steps have been described above generally in terms of their functions. Whether such functions are implemented as hardware or software depends on the design requirements imposed on a specific application and the overall system. Those skilled in the art may implement the described functions in various ways for each of specific applications, but such implementations should not be construed as departing from the scope of the present invention.

In a hardware implementation, processing units used to perform the techniques may be implemented as one or more ASICs, DSPs, digital signal processing devices (DSPDs), programmable logic devices (PLDs), field programmable gate arrays (FPGAs), processors, controllers, microcontrollers, microprocessors, electronic devices, other electronic units designed to perform the functions described in the present disclosure, computers, or a combination thereof.

Accordingly, the various exemplary logic blocks, modules, and circuits described in connection with the present invention may be implemented or performed by any combination of a processor, a DSP, an ASIC, an FPGA or other programmable logic devices, discrete gate or transistor logic, discrete hardware components, or devices designed to perform the functions described herein. A processor may be a microprocessor, but as an alternative, a processor may be any controller, microcontroller, or state machine. A processor may also be implemented as a combination of computing devices, for example, a DSP and a microprocessor, multiple microprocessors, one or more microprocessors in conjunction with a DSP core, or any other components.

In a firmware and/or software implementation, the present invention may be implemented as instructions stored on a computer-readable medium, such as a random access memory (RAM), a read-only memory (ROM), a non-volatile random access memory (NVRAM), a programmable read-only memory (PROM), an erasable programmable read-only memory (EPROM), an electrically erasable PROM (EEPROM), a flash memory, a compact disc (CD), or a magnetic or optical data storage device. The instructions may be executable by one or more processors and may cause the processor(s) to perform specific aspects of the functions described in the present disclosure.

When implemented in software, the present invention may be stored, as one or more instructions or codes, on a computer-readable medium or transmitted therethrough. Computer-readable media include both computer storage media and communication media, including any medium that facilitates transfer of a computer program from one place to another. Storage media may be any available media capable of being accessed by a computer. By way of example and not limitation, such computer-readable media may include a RAM, a ROM, an EEPROM, a CD-ROM, other optical disk storage devices, magnetic disk storage devices, other magnetic storage devices, or any other medium that may be used to transfer or store desired program code in the form of instructions or data structures and that may be accessed by a computer. Alternatively, any connection may be properly referred to as a computer-readable medium.

For example, if software is transmitted from a website, server, or other remote sources using a coaxial cable, fiber optic cable, twisted pair, digital subscriber line (DSL), or wireless technologies such as infrared, radio, and microwave, the coaxial cable, fiber optic cable, twisted pair, digital subscriber line, or wireless technologies such as infrared, radio, and microwave are included within the definition of media. Disk and disc, as used herein, include CDs, laser discs, optical discs, digital versatile discs (DVDs), floppy disks, and Blu-ray discs, where disks typically reproduce data magnetically, while discs reproduce data optically using lasers. Combinations of the above should also be included within the scope of computer-readable media.

A software module may reside in a RAM memory, a flash memory, a ROM memory, an EPROM memory, an EEPROM memory, registers, a hard disk, a removable disk, a CD-ROM, or any other types of storage media known. An exemplary storage medium may be connected to a processor such that the processor may read information from or write information to the storage medium. Alternatively, the storage medium may be integrated into a processor. A processor and a storage medium may reside within an ASIC. The ASIC may reside within a user terminal. Alternatively, the processor and the storage medium may reside as separate components in a user terminal.

Although the embodiments have been described above as utilizing aspects of the presently disclosed subject matter in one or more standalone computer systems, the present invention is not limited thereto and may be implemented in conjunction with any computing environment, such as a network or distributed computing environment. Furthermore, aspects of the subject matter in the present disclosure may be implemented in multiple processing chips or devices, and storage may be similarly affected across multiple devices. Such devices may include PCs, network servers, and portable devices.

Although the present invention has been described in connection with some embodiments in this specification, various modifications and changes may be made without departing from the scope of the present invention that may be understood by those skilled in the art to which the invention of the present disclosure pertains. In addition, such modifications and changes should be considered to fall within the scope of the claims appended to this specification.

1. A method for generating a broadcast cue sheet performed by at least one processor, comprising:
receiving a user input comprising information for specifying a product;
extracting one or more keywords from review data associated with the product; and
generating the broadcast cue sheet on the basis of the one or more keywords using a language generation model.

2. The method for generating a broadcast cue sheet of claim 1, wherein the extracting of one or more review keywords comprises:
generating at least one piece of answer data from at least some of the review data on the basis of a plurality of predetermined questions using a language model; and
extracting review keywords associated with the product on the basis of the at least one piece of answer data.

3. The method for generating a broadcast cue sheet of claim 2, wherein the extracting of the review keywords associated with the product comprises:
converting the answer data for the plurality of predetermined questions into embedding vectors;
generating at least one group on the basis of a distance between the embedding vectors; and
extracting a representative keyword from each of the at least one group.

4. The method for generating a broadcast cue sheet of claim 3, wherein the extracting of the representative keyword comprises:
determining the representative keyword on the basis of the frequency of keywords included in the at least one group among the review data.

5. The method for generating a broadcast cue sheet of claim 1, wherein the generating of the broadcast cue sheet comprises:
generating a bullet-point short sentence comprising the one or more keywords.

6. The method for generating a broadcast cue sheet of claim 5, wherein the bullet-point short sentence comprises:
a short sentence combining the one or more keywords and nouns associated with the product or a short sentence combining the one or more keywords and adjectives associated with the product.

7. The method for generating a broadcast cue sheet of claim 5, wherein the bullet-point short sentence comprises:
a short sentence combining the one or more keywords and a timely short sentence.

8. The method for generating a broadcast cue sheet of claim 5, wherein the generating of the bullet-point short sentence comprises:
removing predetermined forbidden words from the bullet-point short sentence.

9. The method for generating a broadcast cue sheet of claim 5, wherein the generating of the broadcast cue sheet further comprises:
generating a long sentence on the basis of the bullet-point short sentence.

10. The method for generating a broadcast cue sheet of claim 9, wherein the generating of the long sentence comprises:
generating the long sentence by adding sentence components to the bullet-point short sentence, enabling meaning of the broadcast cue sheet to be conveyed.

11. The method for generating a broadcast cue sheet of claim 9, wherein the generating of the long sentence comprises:
generating the long sentence reflecting a writing style of a show host on the basis of the bullet-point short sentence using a machine learning model.

12. The method for generating a broadcast cue sheet of claim 9, wherein the generating of a broadcast cue sheet on the basis of the one or more keywords further comprises:
receiving a prompt associated with composition of the broadcast cue sheet; and
generating the broadcast cue sheet on the basis of the long sentence and the prompt, and
wherein the prompt comprises information associated with at least one of an opening block, a body block, or a closing block.

13. The method for generating a broadcast cue sheet of claim 1, further comprising:
outputting at least one of the one or more keywords or the broadcast cue sheet.

14. The method for generating a broadcast cue sheet of claim 13, further comprising:
modifying the one or more keywords in response to a user input for modifying the one or more keywords; and
updating the broadcast cue sheet on the basis of the one or more modified keywords.

15. The method for generating a broadcast cue sheet of claim 1, further comprising:
generating a voice of a show host from the broadcast cue sheet using a voice synthesis model.

16. The method for generating a broadcast cue sheet of claim 1, further comprising:
updating the broadcast cue sheet on the basis of personal information of a show host in response to a user input associated with the personal information of the show host.

17. A non-transitory computer-readable recording medium recording instructions for executing the method for generating a broadcast cue sheet according to claim 1, on a computer.

18. A system for generating a broadcast cue sheet, comprising:
a communication module;
a memory; and
at least one processor connected to the memory and configured to execute at least one computer-readable program included in the memory,
wherein the at least one program comprises instructions for
receiving a user input comprising information for specifying a product,
extracting one or more keywords from review data associated with the product, and
generating the broadcast cue sheet on the basis of the one or more keywords using a language generation model.
